(19) United States
(12) Patent Application Publication
(10) Pub. No.: US 2007/0017457 A1
(43) Pub. Date: Jan. 25, 2007

(54) ANIMAL TRANSPORT BUMPER

(76) Inventor: Andrew Jackson, Amherst, VA (US)

Correspondence Address: LOUIS VENTRE, JR, 2483 OAKTON HILLS DRIVE, OAKTON, VA, 22124-1530, US

(21) Appl. No.: 11/161,153

(22) Filed: Jul. 25, 2005

(51) Int. Cl. A01K 29/00

(52) U.S. Cl. 119/843

(57) ABSTRACT

An inflatable bumper and method of using the bumper in an animal transportation carrier to protect against the hazards of lateral dynamic forces incident to transit, particularly directional changes, vehicle swerves, sudden stops, or accidents. The invention provides this protection while minimizing stress and discomfort of the animal. The bumper is composed of a mounting plate (40), a skirt segment (10) providing side walls; a bumper face covering (30); inflatable bags (50); an inflation tube (60); and a valve (70) to inflate and deflate the inflatable bags. In the method of the invention, the bumper is installed on one or two carrier walls, inflated after the animal is loaded on the transport and deflated immediately prior to the unloading the animal.

### FIELD OF INVENTION

In the field of animal transportation, an inflatable bumper and method of using the bumper in an animal transportation carrier to protect against the hazards of lateral dynamic forces incident to transit, particularly directional changes, vehicle swerves, sudden stops, or accidents. The invention provides this protection while minimizing stress and discomfort of the animal.

### DESCRIPTION OF PRIOR ART

The invention has a primary, but not exclusive application, to carriers for horses. For clarity of discussion, horses are used as the primary example. However, the invention may be used in the conveyance of other animals, which are transported in a standing position.

Horses are typically transported to various locations by land, sea or air in a standing position. No matter the animal or carrier used, such transportation typically exposes the animal to accidental injury from directional changes, swerves, sudden stops, or accidents.

Such animal conveyance is regularly performed today by walking the animal into the carrier, for example in trucks, trailers, rail mounted carriages, aircraft or shipping containers. U.S. Pat. No. 5,513,595 by Chatterton is an example of a horse trailer. The '595 patent teaches the use of a chest bar to limit the forward movement of the horse. It further instructs on using an adjustable rear support to accommodate different sized animals and a closable rear gate to form a back wall. Thus, the '595 patent discloses an invention wherein the animal is limited in forward and backward motion within the carrier, but does not address protection of the animal for lateral or sideways motion, other than inherently by the carrier's sidewalls. However, reliance on the walls of the carrier, risks injuring the horse either by the horse directly impacting the wall structure or in the horse falling after unexpectedly loosing balance by too great a sideways reaction.

In the field of shipping inanimate objects, inflatable yieldable braces and dunnage structures for load bracing are well know. None, however, are suitable for use for live loads, especially horses. Additionally, prior art describes the use of compressed air systems to fill dunnage bags typically on an 18-wheeler tractor-trailer.

In some freight systems, a wall is moved to butt up against the freight and prevent its movement during shipment. For example, U.S. Pat. No. 3,427,995 by Stafford teaches the use of movable bulkhead located at each end of a railroad flat car, which is moveable by inflating and expanding a dunnage bag braced behind the movable wall and against a stationary bulkhead. The bag moves the moveable wall towards and against the cargo. The wall is relocated when the dunnage bags are depressurized and collapsed. Using a wall to enclose a horse is inadequate and inappropriate because it adds to the animal's unease at being confined in an enclosed area. An important feature of the present invention is the limited size of the cushion above and below the body of the animal to minimize animal stress and adverse reaction that might otherwise occur with too confining an enclosure. The curved cushioned shape of the present invention addresses the singularly unique objective of protecting a horse and avoiding confinement of the horse in an uncomfortable and stressful enclosure.

Inanimate freight systems sometimes employ inflatable elastic cushions, but again these would be inadequate and inappropriate for animal transport. U.S. Pat. 3,115,977 by Mirando teaches such a system supported from stationary partitions in a freight car by hooks affixed to the partition engaging eyelets provided on the cushions. This invention is directed towards stowing and shipping watermelons in freight cars and does not form a specific shape to provide lateral stability, but rather provides a cushion on which to place watermelons wherein the cushions are inflated to create a compact mass that bulges into the space between the melons. The present invention is different in that the cushions are not intended to bulge around the horse, but rather to provide a shaped cushion in proximity to, or light contact with, the body of the horse to act as a bumper in response to the dynamic transport forces. Attempting to lock a horse in place in a manner similar to that described in the '977 patent could be dangerous to the health and well being of a horse.

Easily attachable dunnage bags are used for inanimate freight shipments. U.S. Pat. No. 4,145,973 by Baxter discloses attaching an uninflated dunnage bag using an adhesive strip. Flexible dunnage bag placement enables filling both the voids between the articles being transported and between the articles and the walls of the cargo space of the vehicle. The '973 invention would be inadequate and inappropriate for animal transport because filling all of the void space between the animal and the walls would be dangerous to the health and well being of the animal. The present invention is fundamentally different because it is not a universal dunnage bag that inflates to fill the voids. Rather, it is a device containing inflatable bags and it has a specific shape for a unique application. It is not designed to fill the voids, but rather be a bumper against movement of a living animal in response to lateral dynamic forces in the movement of the vehicle.

Inanimate freight dunnage systems sometimes employ selectively inflatable and deflatable air bags, which can be re-used. As with other such dunnage bag devices, they are unsuitable for use with animals because they are intended to fill up the void space between items being shipped. U.S. Pat. No. 5,466,104 by Gatwood discloses such a cargo cushioning apparatus. The '104 patent describes an application in cargo containers. Each air bag includes an air inlet, an air outlet, and a pressurized air supply assembly for inflating the air bags. The '104 disclosure is additionally different in several important aspects from the present invention, while there are a plurality of bags used in the '104 patent, these bags are not enclosed in a single bumper assembly, rather they are deployed and inflated individually in the quantity required for the freight being transported. The '104 patent maintains a pressurized air supply on the trailer, required for repetitive use of the bags. The present invention does not require a pressurized air supply. Next, the '104 patent requires significant volume in a storage container needed to store the bags when not in use. The present invention permits the bumper assembly to remain on the wall when the bags are deflated within the self-storing bumper assembly.

A pneumatic inflation system for dunnage bags is described in U.S. Pat. No. 6,746,190 by Freeman. The '190 patent discloses an inflation system secured to a freight carrier, such as a tractor-trailer. The inflation system is available to inflate reusable air bags to cushion freight during shipment from one location to another. This invention is unlike the present invention in that the air bags disclosed in this patent are large inflatable bags singularly deployed between units of freight in a tractor-trailer. As with the other dunnage systems in the prior art, they are unsuited for animal transport. In addition, those bags used in the '190 patent are not within a bumper assembly nor are they contoured to the shape of the freight, but rather in the nature of dunnage bags, simply fill up the empty space between freight units to secure their location within the trailer.

Accordingly, several objects and advantages of the present invention are to provide an easily deployable and reusable bumper for animal transport that will protect the animal against injury from lateral dynamic forces of transport while minimizing animal stress; to provide a bumper with a shape and deployment arrangement that is comfortable to the animal when it is in use; to provide a bumper that is easily inflated using a hand pump, a compressed air source or an electric air pump; and to provide a bumper that can be easily retracted and stowed in place with a minimum of required storage volume within a carrier.

It is therefore apparent that a need exists for a reusable animal transport bumper.

### BRIEF SUMMARY OF THE INVENTION

An inflatable and reusable bumper deployed in a carrier vehicle for a standing animal to protect the animal against the hazards of lateral dynamic forces incident to transit, particularly directional changes and vehicle swerves, sudden stops, or accidents. The base of the bumper nearest the wall is a mounting plate. Attached to the mounting plate is a skirt segment that extends around the perimeter of the mounting plate and attaches to a bumper face covering forming the outer wall of the bumper. Within the skirt segment and between the bumper face covering and the mounting plate are a plurality of fluidly interconnected air bags. In the method of the invention, the mounting plate is attached to the wall of the carrier vehicle. The air bags are inflated after an animal is present in the carrier vehicle. When so inflated, the outside wall of the bumper extends the outer face of the bumper away from the wall in close proximity to, or in gentle contact with, an animal. In addition, when so inflated, the outer wall takes on the gentle curve of the animal body. The air bags are deflated immediately before the animal exits the carrier vehicle.

### BRIEF DESCRIPTION OF THE DRAWING

FIG. 1 is a top view of the animal transport bumper.

FIG.2 is a cross-sectional side view of the animal transport bumper.

### DETAILED DESCRIPTION OF THE INVENTION

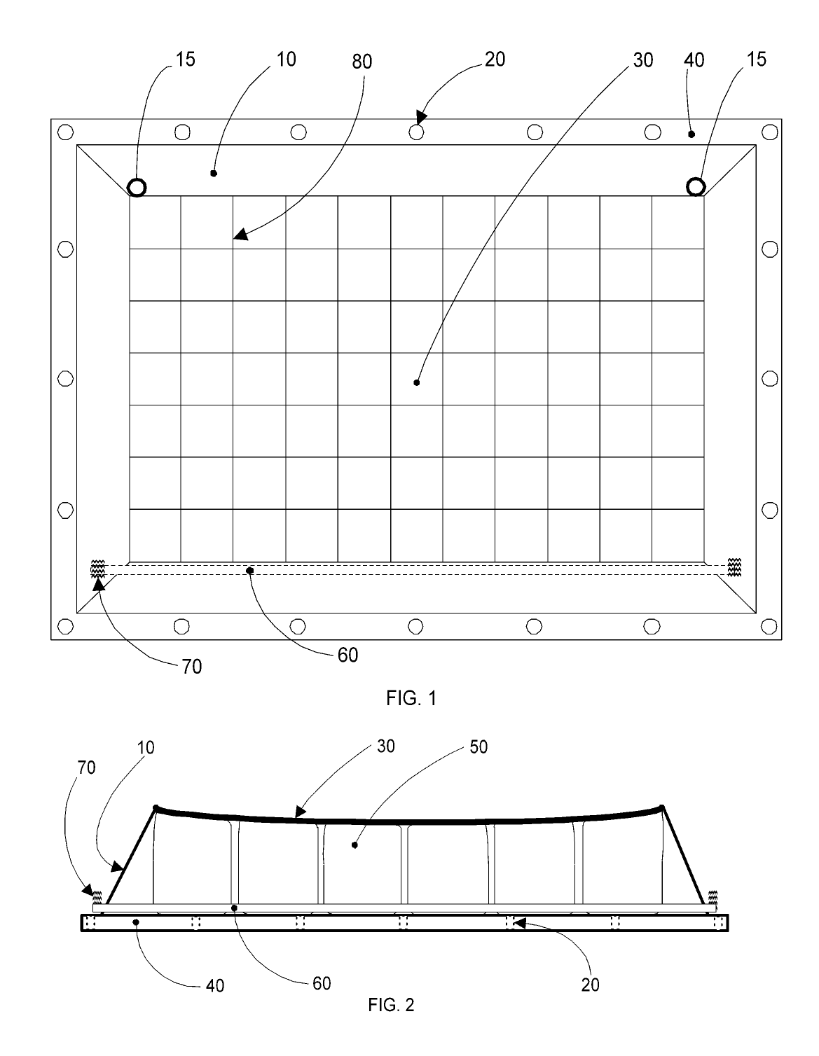

The preferred embodiment of the animal transport bumper is shown in FIG. 1 and FIG. 2 The bumper is composed of a mounting plate (40) having mounting holes (20), a skirt segment (10) providing side walls; a bumper face covering (30) with pleats (80); inflatable bags (50); an inflation tube (60) to fluidly interconnect the inflatable bags; a valve (70) to inflate and deflate the inflatable bags.

The preferred embodiment of the animal transport bumper has a rectangular shape, which has a length of about 7 feet, a height of about 3 feet, a depth of about 1 foot in the inflated position, and a depth of about 3 inches in the deflated position. This shape is suitable for use with a horse. Other shapes may be employed for different size animals. For example a square shape or a circular shape might be used in other embodiments.

In the preferred embodiment, the mounting plate (40) serves as the means to mount the bumper on a carrier wall and preserve the integrity of the animal transport bumper components within a functioning unit. It is desirable, although not absolutely essential, that the bumper assembly be as light as possible to facilitate its relocation and removal from the carrier. This is translated into using a mounting plate of wood, aluminum, steel, plastic, or other material that provides a minimum thickness to maintain unit integrity of the bumper during its installation, storage, relocation and removal. The mounting plate need not itself be capable of sustaining the weight of the animal because that functionality is provided by the wall structure of the carrier. In the preferred embodiment, the mounting plate is made of three eights inch plywood. In other embodiments, where the mounting plate must be mounted to provide support for the weight of the animal, a thicker, sturdier mounting plate is utilized.

In most embodiments, the animal transport bumper has a means for attaching the mounting plate on a carrier wall. As shown in FIG. 1, this means for attaching is a number of grommeted holes (20) along its perimeter to facilitate attaching the mounting plate (40) on an animal transport carrier wall. In the preferred embodiment, the holes are about 2 inches in diameter. In other embodiments, the means for attaching is Velcro, or such other well known temporary means, to position the animal transport bumper on the carrier wall. Such temporary means of attachment enhance its movability to various heights and longitudinal positions within a carrier. In yet other embodiments, there are no means for attaching and the mounting plate is user installed with nuts and bolts or other well known means for attaching.

The skirt segment (10) is attached around the perimeter of the mounting plate at one end and to the bumper face covering (30) forming the outer wall of the animal transport bumper at the other end. The skirt segment is intended to provide side walls to the animal transport bumper when the inflatable bags (50) are inflated. The skirt segment may be made as an integral part of the bumper face covering, but must have sufficient depth to contain the bags when inflated, yet permit the animal transport bumper to have an inflated depth suitable for its purpose of protecting the animal from lateral dynamic forces of transit. In an alternative embodiment, the skirt segment has rings (15) located near the top edge corners of the bumper face cover. The rings provide a means to hang the front of the bumper when the inflatable bags (50) are deflated. Hanging the front of the bumper from these rings (15) prevents the bumper from drooping to floor level and prematurely wearing where it contacts the floor.

The skirt segment (10) may be made of any suitable material that can sustain the tensile forces incident to containing the inflated bags and maintaining integrity when in use. Many such materials, for example leather, plastic and rugged textiles such as canvass, are well known to those skilled in the art.

The bumper face covering (30) forming the outer wall of the animal transport bumper may be made of any similarly durable material and ideally, would be made of the same material as the skirt segment. In the preferred embodiment shown in FIG. 1, the bumper face covering is shown with pleats about 6 inches on a side. A pleated bumper face covering is preferred because it helps to keeping the animal cooler than a continuous flat covering. In an alternate embodiment, the inside wall of the bumper face covering is padded or cushioned on with foam to provide a smoother, softer outer wall.

There are seven inflatable bags (50) shown in side view in FIG. 2 in an inflated position. Preferentially, the bags are oriented such that once inflated their longitudinal center lines are parallel with the shorter side of the animal transport bumper. However, in alternate embodiments the bags may be oriented along the longer side of the animal transport bumper. The bags have an inflated shape and depth so as to establish a concave outer wall of the animal transport bumper, roughly approximating the body contour of a horse. In the preferred embodiment, all the bags are about 10 inches in width. The outer two inflatable bags are about 8 to 10 inches in inflated depth, the next inner two bags are about 7.5 to 8.5 inches in inflated depth, the next inner two bags are about 6.5 inches in inflated depth, and the last center bag is about 6 inches in depth.

The inflation tube (60) provides the means to fluidly interconnect the inflatable bags so that all the bags may be inflated and deflated as a unit through the inflation/deflation valve (70). In the preferred embodiment, the inflation tube (60) is fixed to the mounting plate and serves to hold the bags in approximate position within the animal transport bumper. There are two valves on the inflation tubes at both ends of the animal transport bumper. This feature allows a valve to be located towards the entry door no matter whether the animal transport bumper is located on the left or right side of the animal transport carrier. Location of the valve towards the entry door makes it easier to inflate and deflate the bags. In other embodiments, the inflation tube is not fixed to the mounting plate and the bags take their position by virtue of being inflated.

Alternative embodiments of the invention include a means for inflating the animal transport bumper. Such means may include an air pump, which may be a hand pump similar to a bicycle pump or an electric pump of the kind readily available with products like inflatable mattresses, or one that is powered by direct current to enable it to be powered by a vehicle battery.

In an alternative embodiment of the invention, the animal transport bumper has a means for removing a horse with the animal transport bumper from an overturned carrier vehicle. Such means also serves to easily install and remove the animal transport bumper. This means typically comprises three components, a flat panel and two rails, each of the rails having a channel slightly larger than the width of the panel. The animal transport bumper is attached to the panel, for example a three quarter inch plywood board, having a reinforced slot centrally located at the ends to facilitate handling. One of the rails is mounted to the upper sidewall or the ceiling of the carrier vehicle and the other on the lower sidewall or the floor of the carrier vehicle. The channels on the rails align vertically and provide a secure means for slidably installing the panel with the bumper attached into a carrier vehicle.

In the method of using this alternative embodiment in the event of an accident, the animal transport bumper is first installed by sliding it into an animal carrier vehicle; then, after loading the animal for transport, the inflatable bags are inflated. When an accident turns the carrier vehicle on its side, the animal and animal transport bumper are safely pulled out of the carrier vehicle together on the panel. The step of pulling the animal and animal transport bumper is easily accomplished by, for example, attaching a winch or rope to the slot in the panel and pulling the panel from the rail channel.

In the method of the invention, the animal transport bumper is installed on one or two carrier walls in a deflated position. Since carrier vehicles come in various sizes and configurations, one bumper is used when there is only one wall adjacent to the animal. In carriers for only one animal, a bumper would ideally be installed on the walls on both sides of the animal. Then, after the animal is loaded on the carrier, each installed animal transport bumper is inflated. After reaching the travel destination, each such animal transport bumper is deflated to enable unloading the animal.

Although the description above contains many uses, these should not be construed as limiting the scope of the invention but as merely providing illustrations of some of the embodiments of this invention. Thus, the scope of the invention is determined by the appended claims and their legal equivalents rather than by the examples given.

What is claimed is:

1. An animal transport bumper comprising, a mounting plate; a skirt segment attached to the periphery of the mounting plate; a bumper face covering attached to the skirt segment; a plurality of inflatable bags within the volume formed by the mounting plate, skirt segment and bumper face covering; an inflation tube to fluidly interconnect the inflatable bags; and a valve for inflating and deflating the bags at one end of the inflation tube.

2. The animal transport bumper of claim 1 further comprising means for attaching the mounting plate on a carrier wall.

3. The animal transport bumper of claim 1 further comprising a second valve located at the other end of the inflation tube.

4. The animal transport bumper of claim 1 wherein the bumper face covering is pleated.

5. The animal transport bumper of claim 1 wherein the bumper face covering has an inner cushion of foam.

6. The animal transport bumper of claim 1 having seven inflatable bags which when inflated establish a concave outer wall of the animal transport bumper approximating the body contour of a horse.

7. The animal transport bumper of claim 1 wherein the inflation tube is fixed to the mounting plate to hold the bags in approximate position within the animal transport bumper.

8. The animal transport bumper of claim 1 further comprising a deflation valve.

9. The animal transport bumper of claim 1 further comprising a means for inflating the animal transport bumper.

10. The animal transport bumper of claim 1 further comprising two rings on the skirt segment located near the top edge corners of the bumper face cover.

11. The animal transport bumper of claim 1 further comprising a means for removing a horse with the animal transport bumper from an overturned carrier vehicle.

12. A method of using the animal transport bumper of claim 11 in the event of an accident that overturns an animal transport vehicle comprising the steps of, sliding said means for removing into an animal carrier vehicle; inflating the bags after loading said means for removing; and pulling the animal and animal transport bumper from the carrier vehicle.

13. A method of using the animal transport bumper of claim 1 comprising the steps of installing an animal transport bumper on an interior side wall of an animal carrier vehicle; inflating the bags after loading the animal for transport; and deflating the bags after reaching the transport destination.

14. The method of using the animal transport bumper of claim 13 further comprising the step of installing a second animal transport bumper on the other interior side wall of an animal carrier vehicle; inflating the bags in the second animal transport bumper after loading the animal for transport; and deflating said bags after reaching the transport destination.
